(19) United States
(12) Patent Application Publication
(10) Pub. No.: US 2026/0126841 A1
(43) Pub. Date: May 7, 2026

(54) UNIVERSAL SERIAL BUS POWER DELIVERY DEVICE AND METHOD OF INVALID HARD RESET DETECTION

(71) Applicant: Nuvoton Technology Corporation, Hsinchu Science Park (TW)

(72) Inventor: Chih-Ming CHEN, Jhuangwei Township (TW)

(21) Appl. No.: 19/298,715

(22) Filed: Aug. 13, 2025

(30) Foreign Application Priority Data
Nov. 5, 2024 (TW) 113142206

(51) Int. Cl. G06F 1/26

(52) U.S. Cl. CPC G06F 1/266

(57) ABSTRACT

A universal serial bus (USB) power delivery device is provided, including a bit detector, a start of packet (SOP) cycle counter, a reset detector, and a flag generator. The bit detector receives and detects an input data signal, and enables a preamble confirmation signal in response to a preamble byte in the input data signal. The SOP cycle counter starts counting and enables an SOP enable signal in response to the preamble confirmation signal being disabled. The reset detector receives and determines whether the input data signal includes codes related to a hard reset, to output an invalid hard reset signal and a K code confirmation signal. The flag generator receives the SOP enable signal, the invalid hard reset signal, the K code confirmation signal, and a reset enable signal, to output an invalid hard reset flag to an event recorder.

### CROSS REFERENCE TO RELATED APPLICATIONS

This application claims priority of Taiwan patent application No. 113142206, filed Nov. 5, 2024, the entirety of which is incorporated by reference herein.

### TECHNICAL FIELD

The present disclosure relates to a universal serial bus (USB) power delivery (PD) device, and, in particular, it relates to a USB PD device and a method for detecting invalid hard reset events.

### BACKGROUND

In universal serial bus (USB) power delivery (PD), transmitted packet sequences usually have a valid hard reset event during the testing or actual use of a USB PD device. In addition, the transmission process may be disturbed (by noise, for example), causing the transmitted packet sequence to have bits become inverted due to interference, which may lead to an invalid hard reset event. Therefore, a solution is needed to enable USB PD devices to perform a hard reset when a valid hard reset event occurs, while ignoring invalid hard reset events.

### BRIEF SUMMARY

An embodiment of the present disclosure provides a universal serial bus (USB) power delivery device, comprising a bit detector, a start of packet (SOP) cycle counter, a reset detector, and a flag generator. The bit detector is configured to receive and detect an input data signal, and is configured to enable a preamble confirmation signal in response to a preamble byte in the input data signal. The SOP cycle counter is configured to start counting and enable an SOP enable signal in response to the preamble confirmation signal being disabled. The reset detector is configured to receive and determine whether the input data signal includes codes related to a hard reset, to output an invalid hard reset signal and a K code confirmation signal. The flag generator is configured to receive the SOP enable signal, the invalid hard reset signal, the K code confirmation signal, and a reset enable signal, to output an invalid hard reset flag to an event recorder.

According to an embodiment of the present disclosure, in response to the invalid hard reset signal being disabled, the flag generator disables the invalid hard reset flag, and the disabled invalid hard reset flag indicates a hard reset event does not exist. In response to the preamble confirmation signal being enabled, or in response to the SOP cycle counter counting to a value greater than a preset value, the SOP cycle counter disables the SOP enable signal.

An embodiment of the present disclosure provides a method for detecting an invalid hard reset, comprising disabling a preamble confirmation signal in response to an input data signal without a preamble byte. The method further comprises starting to count using a start of packet (SOP) cycle counter and outputting an SOP enable signal in response to the preamble confirmation signal being disabled. The method further comprises generating a K code confirmation signal and an invalid hard reset signal in response to the preamble confirmation signal and the SOP enable signal. The method further comprises outputting an invalid hard reset flag to an event recorder in response to the SOP enable signal, the K code confirmation signal, the invalid hard reset signal, and a reset enable signal.

According to an embodiment of the present disclosure, the SOP enable signal is disabled in response to the SOP cycle counter reaching a value that is greater than a preset value, or in response to the preamble confirmation signal being enabled. The invalid hard reset flag is enabled in response to the invalid hard reset signal and the SOP enable signal being enabled.

### BRIEF DESCRIPTION OF THE DRAWINGS

The present disclosure can be more fully understood by reading the subsequent detailed description and examples with references made to the accompanying drawings, wherein:

FIG. 1 is a schematic diagram of a packet specification according to an embodiment of the present disclosure.

FIG. 2 is a block flow chart of a universal serial bus (USB) power delivery (PD) device detecting a hard reset event according to an embodiment of the present disclosure.

FIG. 3 is a flow chart of a flag generator generating an invalid hard reset flag according to an embodiment of the present disclosure.

FIG. 4 is a timing diagram of a USB PD device detecting an invalid hard reset event according to an embodiment of the present disclosure.

### DETAILED DESCRIPTION

To make the aforementioned and other objects, features, and advantages of the present disclosure more clearly understandable, preferred embodiments are listed below and are described in detail below regarding the accompanying drawings:

Some embodiments are summarized below so that those with ordinary skills in the art can more easily understand the embodiments of the present disclosure. However, these embodiments are only examples and are not used to limit the embodiments of the present disclosure. It will be understood that those with ordinary skills in the art can adjust the embodiments described below according to needs, such as changing the process sequence and/or including more or fewer steps than described here, and these adjustments are not It does not exceed the scope of the embodiments of the present disclosure.

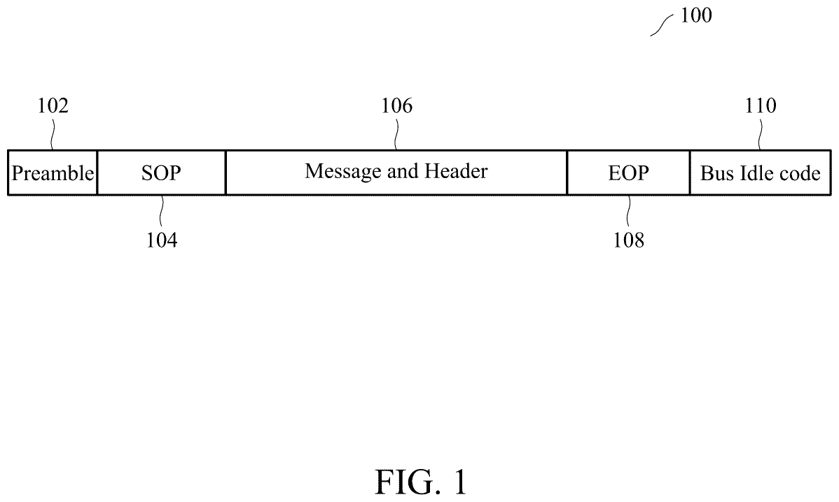

FIG. 1 is a schematic diagram of a packet specification 100 illustrated according to an embodiment of the present disclosure. The packet specification 100 can be used for transmission on a universal serial bus (USB) power delivery (PD) device. As shown in FIG. 1, the packet specification 100 includes a preamble 102, a packet start code 104, a message and header 106, a packet end code 108, and a bus idle code 110. Among them, the preamble 102 indicates that a packet is about to start and is composed of adjacent “0”s and “1”s. For example, the preamble 102 can be a 32-bit or 64-bit code arranged in “0101 . . . ” or “1010 . . . ”. The packet start code 104 indicates the beginning of a packet and includes information about a hard reset event. The message and header 106 include information about a packet and other reset events (such as soft reset, data reset, cable reset, etc.). The packet end code 108 indicates the end of a packet, and the bus idle code 110 can force the bus to be cleared, preparing it for receiving the next packet.

As described above, the packet start code 104 includes information about a hard reset event, and the message and header 106 include information about a packet and other reset events. However, in the process of transmitting a packet, the information may be erroneous (e.g., bits are inverted) due to interference (e.g., noise). For example, the encoding of the hard reset event will only appear in the packet start code 104. However, when certain bits in the message and header 106 are inverted due to interference, the original information may be read as a hard reset event. These hard reset events do not originally exist in the packet and are called an “invalid hard reset event”. Since the hard reset event will reset the power supply and protocol, an invalid hard reset event may cause subsequent transmission or authentication operations to fail. Therefore, there is a need for a method that can prevent a system or device from performing a hard reset due to an invalid hard reset event.

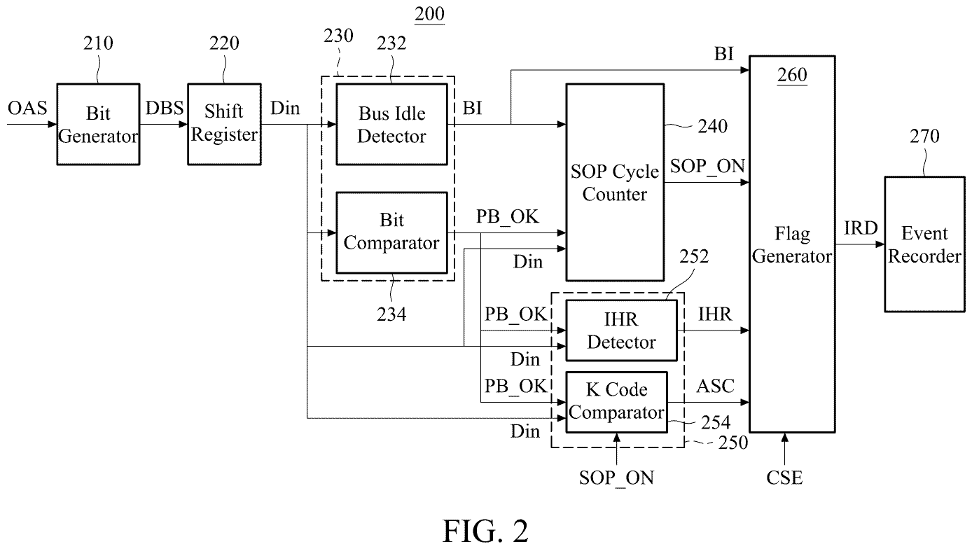

FIG. 2 is a block flow chart of a universal serial bus (USB) power delivery (PD) device 200 detecting a hard reset event according to an embodiment of the present disclosure. The USB PD device 200 includes a bit generator 210, a shift register 220, a bit detector 230, a start of packet (SOP) cycle counter 240, a reset detector 250, a flag generator 260, and an event recorder 270. The bit generator 210 receives an input signal OAS and generates a corresponding digital signal DBS. The shift register 220 receives the digital signal DBS and generates an input data signal Din. The shift register 220 can be a 20-bit shift register, which converts the read digital signal DBS into a 20-bit input data signal Din after each read cycle.

When the shift register 220 reads the digital signal DBS and outputs the input data signal Din, the input data signal Din can be output to a SOP mode determiner (not shown) to determine the SOP mode (e.g., SOP, SOP′, SOP″, etc.) of the packet start code 104 of the current packet. When the SOP mode matches the current component setting (e.g., the setting of the USB PD device 200), the SOP mode determiner generates a reset enable signal CSE with a second level (e.g., logic 1). On the contrary, when the SOP mode does not match the current component setting, the SOP mode determiner generates the reset enable signal CSE with a first level (e.g., logic 0).

The bit detector 230 further includes a bus idle detector 232 and a bit comparator 234. The bus idle detector 232 receives the input data signal Din and outputs a bus idle signal BI according to the content of the input data signal Din (e.g., the content of the packet specification 100 shown in FIG. 1). Specifically, when the input data signal Din read by the bus idle detector 232 does not include a bus idle byte (e.g., the bus idle code 110), the bus idle detector 232 outputs the bus idle signal BI with a first level (e.g., logic 0). When the input data signal Din read by the bus idle detector 232 includes the bus idle byte, the bus idle detector 232 outputs the bus idle signal BI with a second level (e.g., logic 1).

The bit comparator 234 receives the input data signal Din and outputs a preamble confirmation signal PB_OK according to the content of the input data signal Din. Specifically, when the input data signal Din read by the bit comparator 234 does not include a preamble byte (e.g., the 20-bit combination of “0101 . . . ” or “1010 . . . ” in the preamble 102), the bit comparator 234 outputs the preamble confirmation signal PB_OK with a first level (e.g., logic 0) (i.e., the preamble confirmation signal PB_OK is disabled). When the input data signal Din read by the bit comparator 234 includes the preamble byte, the bit comparator 234 outputs the preamble confirmation signal PB_OK with a second level (e.g., logic 1) (i.e., the preamble confirmation signal PB_OK is enabled).

The SOP cycle counter 240 receives the preamble confirmation signal PB_OK and the bus idle signal BI. When the preamble confirmation signal PB_OK and the bus idle signal BI both have a first level (e.g., logic 0), the SOP cycle counter 240 starts counting from zero and simultaneously outputs a start of packet (SOP) enable signal SOP_ON having a second level (e.g., logic 1). Then, when the SOP cycle counter 240 counts to a value greater than a preset value (e.g., a preset time length or a preset value), the SOP cycle counter 240 outputs a SOP enable signal SOP_ON having a first level (e.g., logic 0). The preset value may also indicate a preset SOP cycle length.

The reset detector 250 is configured to determine whether the input data signal Din includes a code related to a hard reset event. For example, when the USB PD device 200 performs data transmission, the received data can be encoded and decoded using 4B/5B encoding technology. The K codes related to the hard reset event are named RST-1 (wherein the 5-bit code is 00111) and RST-2 (wherein the 5-bit code is 11001). In addition, to constitute a hard reset event, four K codes (i.e., 20 bits) arranged in a fixed coding sequence are required. That is, when the reset detector 250 reads a fixed coding sequence arranged as RST-1, RST-1, RST-1, RST-2, it determines that a hard reset event has occurred.

The reset detector 250 further includes an invalid hard reset detector 252 and a K code comparator 254. The invalid hard reset detector 252 receives the preamble confirmation signal PB_OK and the input data signal Din, and compares the input data signal Din with a valid hard reset code (e.g., a fixed code sequence arranged as RST-1, RST-1, RST-1, RST-2) when the preamble confirmation signal PB_OK has a first level (e.g., logic 0). When the comparison result is the same (e.g., at least three K codes among 20 bits of the input data signal Din are the same as the valid hard reset code), the invalid hard reset detector 252 outputs an invalid hard reset signal IHR with a second level (e.g., logic 1), indicating that a hard reset event has occurred. On the contrary, when the comparison result is different (e.g., at least two K codes of 20 bits of the input data signal Din are different from the valid hard reset code), the invalid hard reset detector 252 outputs the invalid hard reset signal IHR with the first level (e.g., logic 0), indicating that no hard reset event has occurred.

The K code comparator 254 receives the preamble confirmation signal PB_OK, the SOP enable signal SOP_ON, and the input data signal Din, and compares the input data signal Din with the valid hard reset code when the preamble confirmation signal PB_OK has a first level (e.g., logic 0) and the SOP enable signal SOP_ON has a second level (e.g., logic 1). When the comparison result is the same (e.g., at least three K codes among 20 bits of the input data signal Din are the same as the valid hard reset code), the K code comparator 254 outputs a K code confirmation signal ASC with a second level (e.g., logic 1). On the contrary, when the comparison result is different (e.g., at least two K codes among 20 bits of the input data signal Din are different from the valid hard reset code), the K code comparator 254 outputs the K code confirmation signal ASC with a first level (e.g., logic 0).

The K code comparator 254 compares the input data signal Din with the valid hard reset code only when the preamble confirmation signal PB_OK has the first level (e.g., logic 0) and the SOP enable signal SOP_ON has the second level (e.g., logic 1). Therefore, it can be considered that the K code comparator 254 compares the input data signal Din with the valid hard reset code when the packet start code 104 is read. Since the invalid hard reset detector 252 compares the input data signal Din with the valid hard reset code when the preamble confirmation signal PB_OK has the first level (e.g., logic 0), it can be considered that the invalid hard reset detector 252 performs the comparison during the entire packet reading period after the preamble 102. Under such a design, it can be determined whether a packet has a hard reset event in all contents other than the preamble 102, and it can also be determined whether a packet has a hard reset event in the contents of the packet start code 104. The following will describe in detail how such a design helps to determine whether an invalid hard reset event has occurred.

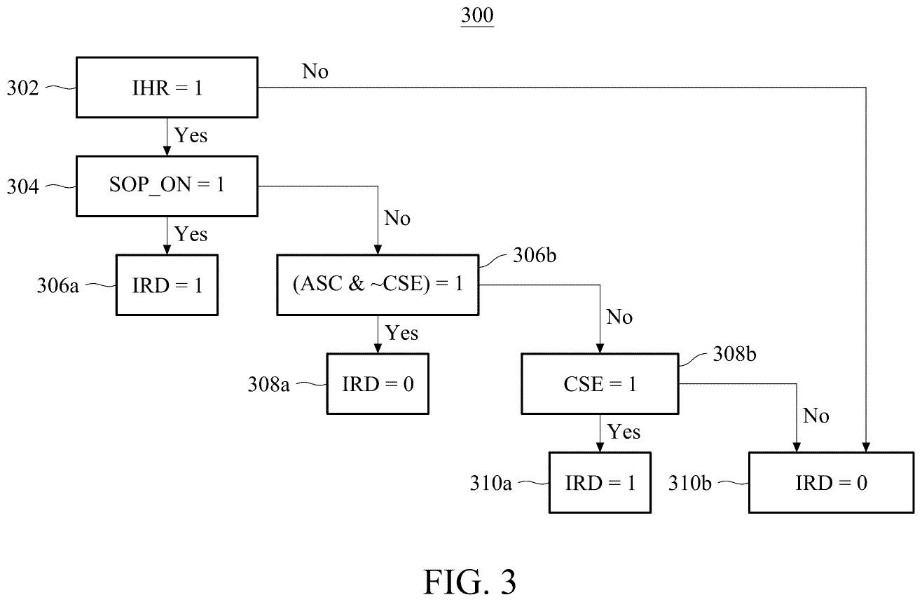

The flag generator 260 receives the bus idle signal BI, the SOP enable signal SOP_ON, the invalid hard reset signal IHR, the K code confirmation signal ASC, and the reset enable signal CSE. When the bus idle signal BI has a second level (e.g., logic 1), the flag generator 260 does not perform any operation. When the bus idle signal BI has a first level (e.g., logic 0), the flag generator 260 outputs an invalid hard reset flag IRD according to the SOP enable signal SOP_ON, the invalid hard reset signal IHR, the K code confirmation signal ASC, and the reset enable signal CSE. The specific operation is described below regarding FIG. 3.

FIG. 3 is a flow chart 300 of the flag generator 260 generating the invalid hard reset flag IRD according to the embodiment of the present disclosure. As described above, when the bus idle signal BI has the second level (e.g., logic 1), the flag generator 260 does not perform any operation. Therefore, the operation shown in the flow chart 300 is the operation performed by the flag generator 260 when the bus idle signal BI has the first level (e.g., logic 0). In step 302, the flag generator 260 determines whether the invalid hard reset signal IHR has the second level (e.g., logic 1). When the invalid hard reset signal IHR does not have the second level, the process proceeds to step 310b, and the flag generator 260 generates the invalid hard reset flag IRD with the first level (e.g., logic 0). When the invalid hard reset signal IHR has the second level, the process proceeds to step 304, where the flag generator 260 determines whether the SOP enable signal SOP_ON has the second level (e.g., logic 1).

When the SOP enable signal SOP_ON has a second level (e.g., logic 1), the process proceeds to step 306a, and the flag generator 260 generates an invalid hard reset flag IRD having a second level (e.g., logic 1). When the SOP enable signal SOP_ON does not have a second level, the process proceeds to step 306b, and the flag generator 260 determines whether the K code confirmation signal ASC and the reset enable signal CSE have a second level (e.g., logic 1) and a first level (e.g., logic 0), respectively. When the K code confirmation signal ASC has the second level and the reset enable signal CSE has the first level, the process proceeds to step 308a, and the flag generator 260 generates the invalid hard reset flag IRD having a first level (e.g., logic 0).

When the K code confirmation signal ASC and the reset enable signal CSE do not have the second level and the first level respectively (that is, the K code confirmation signal ASC does not have the second level, or the reset enable signal CSE does not have the first level), the process proceeds to step 308b, and the flag generator 260 determines whether the reset enable signal CSE has the second level (e.g., logic 1). When the reset enable signal CSE has the second level, the process proceeds to step 310a, and the flag generator 260 generates the invalid hard reset flag IRD with the second level (e.g., logic 1). When the reset enable signal CSE does not have the second level, the process proceeds to step 310b, and the flag generator 260 generates an invalid hard reset flag IRD with the first level (e.g., logic 0).

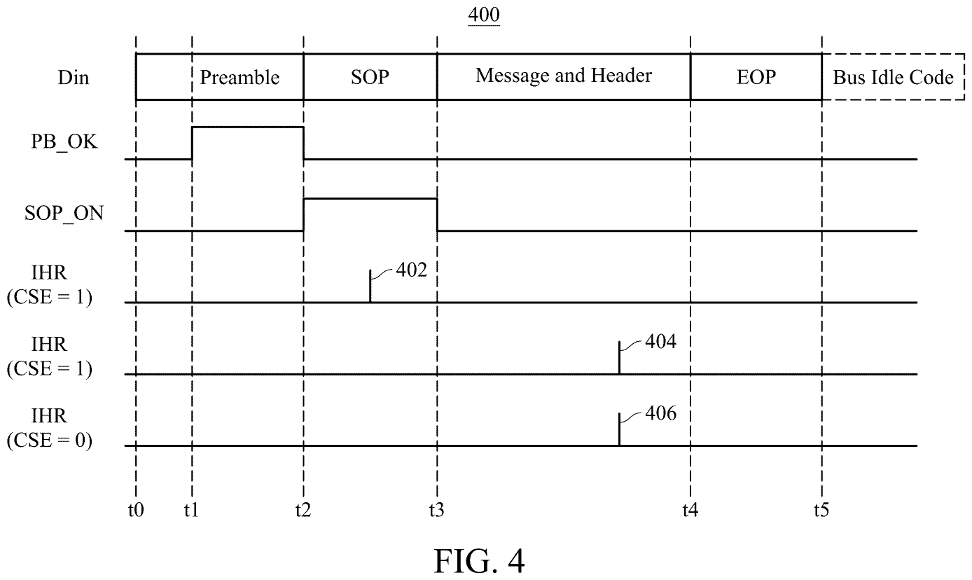

FIG. 4 is a timing diagram 400 of the USB PD device 200 detecting an invalid hard reset event according to the embodiment of the present disclosure. Hard reset events 402, 404, and 406 correspond to the first embodiment, the second embodiment, and the third embodiment, respectively. Referring to FIGS. 2 and 3, at time to, the shift register 220 starts to read the preamble 102 of a packet and outputs the input data signal Din to the bus idle detector 232 and the bit comparator 234. At time t1, the bit comparator 234 detects a 20-bit code sequence of “0101 . . . ” or “1010 . . . ” indicating the preamble 102, and outputs the preamble confirmation signal PB_OK with a second level (e.g., logic 1). Since the preamble confirmation signal PB_OK has the second level (e.g., logic 1), the SOP cycle counter 240 is reset to zero or does not start counting, and outputs the SOP enable signal SOP_ON having the first level (e.g., logic 0).

At time t2, the preamble 102 of the packet has been transmitted, so that the input data signal Din detected by the bit comparator 234 is no longer a 20-bit code sequence arranged as “0101 . . . ” or “1010 . . . ”. The bit comparator 234 outputs the preamble confirmation signal PB_OK with a first level (e.g., logic 0), so that the SOP cycle counter 240 starts counting and outputs an SOP enable signal SOP_ON with a second level (such as logic 1). At the same time, the invalid hard reset detector 252 and the K code comparator 254 that receive the preamble confirmation signal PB_OK with a first level (such as logic 0) start to compare the input data signal Din with the valid hard reset code.

At time t3, the SOP cycle counter 240 counts to a value greater than a preset value (e.g., the preset transmission time of the packet start code 104), thereby outputting the SOP enable signal SOP_ON with a first level (e.g., logic 0). In the first embodiment, the hard reset event 402 occurs between times t2 and t3. Since the hard reset event 402 occurs within the preset transmission time of the packet start code 104, the hard reset event 402 can be regarded as a valid hard reset event (because the code related to the hard reset event should only exist in the packet start code 104). Then, after time t3, since the SOP enable signal SOP_ON is converted from the second level (e.g., logic 1) to the first level (e.g., logic 0), the K code comparator 254 stops comparing the input data signal Din with the valid hard reset code. Meanwhile, since the preamble confirmation signal PB_OK is maintained at the first level (e.g., logic 0), the invalid hard reset detector 252 continues to compare the input data signal Din with the valid hard reset code.

At time t4, the bit detector 230 detects the packet end code 108 indicating the end of packet (EOP) in the input data signal Din. In the second and third embodiments, the hard reset events 404 and 406 occur between times t3 and t4. Since the SOP enable signal SOP_ON at this time has a first level (e.g., logic 0), it means that the hard reset events 404 and 406 do not occur in the SOP cycle (i.e., the period for transmitting the packet start code 104), so the hard reset events 404 and 406 are regarded as invalid hard reset events. That is, in the second and third embodiments, the invalid hard reset detector 252 detects the hard reset events 404 and 406 and outputs the invalid hard reset signal IHR with a second level (e.g., logic 1). However, referring to the first embodiment, the invalid hard reset detector 252 does not detect any hard reset event outside the SOP cycle. Therefore, in the first embodiment, the invalid hard reset detector 252 outputs the invalid hard reset signal IHR having a first level (e.g., logic 0).

At time t5, the bus idle detector 232 detects the bus idle code 110 in the input data signal Din and outputs the bus idle signal BI having a second level (e.g., logic 1), thereby forcing the bus to enter an idle state to prepare for transmitting the next packet.

The following Table 1 lists the multiple signals received by the flag generator 260 and the logic levels of the invalid hard reset flag IRD output after the first embodiment, the second embodiment, and the third embodiment detect the hard reset events 402, 404, and 406, respectively. The SOP mode of the first and second embodiments is consistent with the setting of the current component (such as USB PD device 200), so the reset enable signal CSE has a second level (e.g., logic 1). The SOP mode of the third embodiment is inconsistent with the setting of the current component, so the reset enable signal CSE has a first level (e.g., logic 0).

TABLE 1

| Signal/ | | | |
|---|---|---|---|
| Flag | First Embodiment | Second Embodiment | Third Embodiment |
| IHR | 1 | 1 | 1 |
| SOP_ON | 1 | 0 | 0 |
| ASC | 1 | 0 | 0 |
| CSE | 1 | 1 | 0 |
| IRD | 1 | 1 | 0 |

Referring to Table 1 and FIG. 3, in the first embodiment, the flag generator 260 determines that the invalid hard reset signal IHR has a second level (e.g., logic 1), so the flag generator 260 then performs step 304 and determines that the SOP enable signal SOP_ON has a second level (e.g., logic 1). At this time, the flag generator 260 generates and outputs the invalid hard reset flag IRD with a second level (e.g., logic 1) to the event recorder 270, so that the USB PD device 200 determines the invalid hard reset flag IRD exists (i.e., a hard reset is required). Since the time point at which the hard reset event 402 occurs is within the SOP cycle, the USB PD device 200 determines that the hard reset event 402 is a valid hard reset event and performs a hard reset.

Still referring to Table 1 and FIG. 3, in the second embodiment, the flag generator 260 determines that the invalid hard reset signal IHR has a second level (e.g., logic 1), so the flag generator 260 then performs step 304 and determines that the SOP enable signal SOP_ON does not have a second level (e.g., logic 1). Then, the flag generator 260 performs step 306b and determines that the K code confirmation signal ASC and the reset enable signal CSE do not have a second level (e.g., logic 1) and a first level (e.g., logic 0), respectively. Therefore, the flag generator 260 s step 308b and determines that the reset enable signal CSE has a second level (e.g., logic 1). At this time, the flag generator 260 generates and outputs the invalid hard reset flag IRD with a second level (e.g., logic 1) to the event recorder 270, so that the USB PD device 200 determines the invalid hard reset flag IRD exists (i.e., a hard reset is required). Since the time point at which the hard reset event 404 occurs is outside the SOP cycle, the USB PD device 200 determines that the hard reset event 404 is an invalid hard reset event and does not perform a hard reset.

Referring again to Table 1 and FIG. 3, in the third embodiment, the flag generator 260 determines that the invalid hard reset signal IHR has a second level (e.g., logic 1), so the flag generator 260 then performs step 304 and determines that the SOP enable signal SOP_ON does not have a second level (e.g., logic 1). Then, the flag generator 260 performs step 306b and determines that the K code confirmation signal ASC and the reset enable signal CSE do not have a second level (e.g., logic 1) and a first level (e.g., logic 0), respectively. Therefore, the flag generator 260 performs step 308b and determines that the reset enable signal CSE does not have a second level (e.g., logic 1). Then, the flag generator 260 generates and outputs the invalid reset flag IRD with a first level (e.g., logic 0) to the event recorder 270, so that the USB PD device 200 determines there is no invalid hard reset flag IRD exists (i.e., no hard reset is required). That is, the time point at which the hard reset event 406 occurs is outside the SOP cycle, however, the SOP mode and the setting of the USB PD device 200 are different, so the USB PD device 200 will determine that the hard reset event does not occur in the third embodiment and thus does not perform a hard reset.

The present disclosure provides a USB PD device, which determines through a bit detector whether the content of the input data signal Din is a preamble indicating packet transmission, or a bus idle code indicating forcing the bus to enter an idle state. When it is determined that the content of the input data signal is a preamble and the preamble transmission is completed, the SOP cycle counter starts counting and outputs an SOP enable signal SOP_ON with a second level (e.g., logic 1) indicating being in the SOP cycle. When the SOP cycle counter counts to a value greater than a preset value (i.e., indicating the end of the SOP cycle) while the preamble has not been completely transmitted, or the bit detector reads the bus idle code, the SOP cycle counter is reset to zero, and outputs an SOP enable signal SOP_ON with a first level (e.g., logic 0) indicating being outside the SOP cycle. In addition, the USB PD device further includes an SOP mode detector, which can determine the SOP mode of the transmitted packet through the packet start code, and output a reset enable signal CSE with a second level (e.g., logic 1) when the SOP mode matches the current device setting.

When the preamble transmission is completed, the transmitted packet is detected using an invalid hard reset detector and a K code comparator. When the K code comparator detects a hard reset event that is the same as the current component setting during the SOP cycle, it outputs a K code confirmation signal ASC with a second level (e.g., logic 1). When the SOP cycle ends, the K code comparator ends the operation. The invalid hard reset detector continues to detect whether there is a hard reset event in the packet that is the same as the current component setting until the bit detector detects a bus idle code and forces the bus to enter an idle state. When the invalid hard reset detector detects a hard reset event, it outputs an invalid hard reset signal IHR with a second level (e.g., logic 1).

The flag generator receives and determines whether to output an invalid hard reset flag IRD having a first level (e.g., logic 0) or a second level (e.g., logic 1) according to the SOP enable signal SOP_ON, the K code confirmation signal ASC, the invalid hard reset signal IHR, and the reset enable signal CSE. In one embodiment, the invalid hard reset signal IHR has a first level, indicating that no hard reset event is detected in the packet, so the invalid hard reset flag IRD has a first level (e.g., logic 0), and the USB PD device does not perform a hard reset. In another embodiment, the invalid hard reset signal IHR has a second level, indicating that a hard reset event is detected in the packet. At this time, if the SOP enable signal SOP_ON has a second level, it means that a hard reset event is detected within the SOP cycle. Therefore, the invalid hard reset flag IRD has a second level (e.g., logic 1), and the USB PD device determines it as a valid hard reset event and performs a hard reset.

If both the invalid hard reset signal IHR and the SOP enable signal SOP_ON have the second level, it means that a hard reset event occurs outside the SOP cycle. At this time, if the K code confirmation signal ASC and the reset enable signal CSE have the second level (e.g., logic 1) and the first level (e.g., logic 0), respectively, the invalid hard reset flag IRD has the first level, and the USB PD device will not perform a hard reset. If the K code confirmation signal ASC and the reset enable signal CSE do not have the second level (e.g., logic 1) and the first level (e.g., logic 0), respectively, it is determined whether the reset enable signal CSE has the second level (e.g., logic 1). If the reset enable signal CSE has the second level (e.g., logic 1), the invalid hard reset flag IRD has the second level, and the USB PD device determines it as an invalid hard reset event and does not perform a hard reset. If the reset enable signal CSE has the first level (e.g., logic 0), the invalid hard reset flag IRD has the first level. That is, although an invalid hard reset event occurs, the USB PD device determines that the SOP mode of the packet is different from the current component setting, so no hard reset is performed.

Through the USB PD device and the method for detecting invalid hard reset as described above, hard reset events can be detected for the entire packet. In addition, by determining whether the hard reset event is detected during or outside the SOP cycle, the USB PD device can determine whether the hard reset event is an invalid hard reset event. The USB PD device as described above can further determine the SOP mode of the transmitted packet through the packet start code transmitted during the SOP cycle, and compare the SOP mode with the current component setting. If the comparison result is not the same, the USB PD device will not perform a hard reset when a hard reset event is detected. Such a design can make the determination of the USB PD device of invalid hard reset events more reliable, and effectively filter unnecessary invalid hard reset events. As a result, the USB PD device may avoid unnecessary hard resets of the system due to interference during packet transmission, thereby affecting subsequent transmission or authentication.

What is claimed is:

1. A universal serial bus (USB) power delivery device, comprising:
a bit detector, configured to receive and detect an input data signal, wherein the bit detector is configured to enable a preamble confirmation signal in response to a preamble byte in the input data signal;
a start of packet (SOP) cycle counter, configured to start counting and enable an SOP enable signal in response to the preamble confirmation signal being disabled;
a reset detector, configured to receive and determine whether the input data signal includes codes related to a hard reset, to output an invalid hard reset signal and a K code confirmation signal; and
a flag generator, configured to receive the SOP enable signal, the invalid hard reset signal, the K code confirmation signal, and a reset enable signal, to output an invalid hard reset flag to an event recorder,
wherein, in response to the invalid hard reset signal being disabled, the flag generator disables the invalid hard reset flag, and the disabled invalid hard reset flag indicates a hard reset event does not exist; and
wherein, in response to the preamble confirmation signal being enabled, or in response to the SOP cycle counter counting to a value greater than a preset value, the SOP cycle counter disables the SOP enable signal.

2. The USB power delivery device as claimed in claim 1, wherein the bit detector comprises:
a bus idle detector, configured to enable a bus idle signal in response to a bus idle byte in the input data signal; and
a bit comparator, configured to enable the preamble confirmation signal in response to the preamble byte in the input data signal.

3. The USB power delivery device as claimed in claim 1, wherein the reset detector comprises:
a K code comparator, configured to compare the input data signal and a valid hard reset code in response to the preamble confirmation signal being disabled and the SOP enable signal being enabled, wherein the K code comparator enables the K code confirmation signal in response to a comparison result being the same; and
an invalid hard reset detector, configured to compare the input data signal and the valid hard reset code in response to the preamble confirmation signal being disabled, wherein the invalid hard reset detector enables the invalid hard reset signal in response to a comparison result being the same.

4. The USB power delivery device as claimed in claim 1, wherein the flag generator is configured to:
determine whether the invalid hard reset signal is enabled in response to the preamble confirmation signal being disabled;
determine whether the SOP enable signal is enabled in response to the invalid hard reset signal being enabled; and
enabling and outputting the invalid hard reset flag to the event recorder in response to the SOP enable signal being enabled.

5. The USB power delivery device as claimed in claim 4, wherein the operation of the flag generator determining whether the invalid hard reset signal is enabled further comprises:
the flag generator disables and outputs the invalid hard reset flag to the event recorder in response to the invalid hard reset signal not being enabled.

6. The USB power delivery device as claimed in claim 4, wherein the operation of the flag generator determining whether the SOP enable signal is enabled further comprises:
the flag generator determines whether the K code confirmation signal is enabled and the reset enable signal is disabled in response to the SOP enable signal not being enabled; and
the flag generator disables and outputs the invalid hard reset flag to the event recorder in response to the K code confirmation signal being enabled and the reset enable signal being disabled.

7. The USB power delivery device as claimed in claim 6, wherein the operation of the flag generator determining whether the K code confirmation signal is enabled and the reset enable signal is disabled further comprises:
the flag generator determines whether the reset enable signal is enabled in response to the K code confirmation signal not being enabled or the reset enable signal not being disabled; and
the flag generator enables and outputs the invalid hard reset flag to the event recorder in response to the reset enable signal being enabled.

8. The USB power delivery device as claimed in claim 7, wherein the operation of the flag generator determining whether the reset enable signal is enabled further comprises:
the flag generator disables and outputs the invalid hard reset flag to the event recorder in response to the reset enable signal not being enabled.

9. A method for detecting an invalid hard reset, comprising:
disabling a preamble confirmation signal in response to an input data signal without a preamble byte;
starting to count, using a start of packet (SOP) cycle counter, and outputting an SOP enable signal in response to the preamble confirmation signal being disabled;
generating a K code confirmation signal and an invalid hard reset signal in response to the preamble confirmation signal and the SOP enable signal; and
outputting an invalid hard reset flag to an event recorder in response to the SOP enable signal, the K code confirmation signal, the invalid hard reset signal, and a reset enable signal,
wherein, in response to counting, by the SOP cycle counter, to a value greater than a preset value, or in response to the preamble confirmation signal being enabled, disabling the SOP enable signal; and
wherein, in response to the invalid hard reset signal and the SOP enable signal being enabled, enabling the invalid hard reset flag.

10. The method as claimed in claim 9, further comprising:
disabling the invalid hard reset flag in response to the invalid hard reset signal being disabled;
disabling the invalid hard reset flag in response to the invalid hard reset signal, the SOP enable signal, and the K code confirmation signal being enabled, and the reset enable signal 5 being disabled; or
enabling the invalid hard reset flag in response to the invalid hard reset signal, the SOP enable signal, and the reset enable signal being enabled.
